(19) United States
(12) Patent Application Publication
(10) Pub. No.: US 2008/0020799 A1
(43) Pub. Date: Jan. 24, 2008

(54) Data communication card, program and computer readable recording media

(76) Inventors: Takashi Itamiya, Yokohama (JP); Shigeyuki Sudou, Yokohama (JP)

Correspondence Address: MCDERMOTT WILL & EMERY LLP, 600 13TH STREET, N.W., WASHINGTON, DC, 20005-3096, US

(21) Appl. No.: 11/729,973

(22) Filed: Mar. 30, 2007

(30) Foreign Application Priority Data
May 29, 2006 (JP) 2006-148000

(51) Int. Cl. H04M 1/00

(52) U.S. Cl. 455/558

(57) ABSTRACT

A notebook computer transmits a distribution. confirmation request including a content attribute. A data communication card performs a matching test for the attribute and notifies of a matching result. When a reservation receiving application requests to start reservation receiving, the data communication card synchronizes with a channel for broadcast to start transferring received data to the notebook computer, and switches a state display to STAND-BY state 2. The reservation receiving application sends a receiving end request upon detection of end of the content. The data communication card stops receiving the broadcast channel and returns the state display to STAND-BY state 1.

### CLAIM OF PRIORITY

The present application claims priority from Japanese patent application serial no. 2006-148000, filed on May 29, 2006, the content of which is hereby incorporated by reference into this application.

### BACKGROUND OF THE INVENTION

The present invention relates to a data communication card, a program, and a computer readable recording medium on which the program is recorded. More particularly, the invention relates to a data communication card supporting broadcast and multicast services, a program, and a computer readable recording medium on which the program is recorded.

Mobile communication systems are widely used not only for voice communication services but also for data communication services including multimedia. The notebook computers and PDA terminals for mobile use are designed to be able to receive emails and access the Internet through connection of a data communication card supporting a mobile communication system or connection of a user terminal such as a cellular phone. Generally a wireless link between a wireless base station and a terminal has been established by activating a data communication channel thereof upon execution of an application requested by a user. Thus an independent wireless link has been used for each session of each terminal. Such a wireless interface configuration is suitable for providing point-to-point services.

On the other hand, there are proposed wireless interfaces suitable for a broadcast service that simultaneously transmits common content to many user terminals or a multicast service that transmits content to a specific group of terminals. These are designed to improve the wireless resource usage efficiency through the use of a common wireless link for one or more terminals within an area (also referred to as a sector) covered by a wireless base station, in which content is distributed by a single common source. Examples of the content may include the news distribution, weather report, advertisement, and entertainment program with streaming video.

JP-A No.295170/2000 proposes a channel configuration for connecting a base station and terminals not only by a control channel for transmitting information to perform a predetermined control process and a communication channel for performing communication between arbitrary terminals, but also by a distribution channel for providing broadcast distribution to many terminals. In this case, the terminals receive advertisement in a transition process to a waiting (STAND-BY) state. The terminal moves to STAND-BY state from an off state when the user turns on the terminal switch. Here is the outline of the state transition. The terminal receives annunciation control information periodically sent from the base station by the control channel, and determines whether the own terminal is connectable to the mobile communication system. When determined as connectable, the terminal provides a location registration to the system to allow calling (paging) from the system via the base station, and then waits. The annunciation control information includes information pertaining to the common distribution channel, based on which the terminal receives the advertisement content and stores to a memory provided in the terminal. The advertisement content stored in the memory is reproduced and displayed when the terminal performs another download operation, for example, when the terminal performs the Internet access, using the communication channel.

JP-A No. 525032/2005 describes a method in which transmission data to plural terminals is configured to be sent to the broadcast and multicast services. JP-A No. 525032/2005 discloses combinations of several services including multicast supported on a single carrier. In other-words, it shows that only the broadcast service is supported on the carrier and the terminal can receive the broadcast service without providing the location registration to the system, and that the terminal receives the broadcast and multicast services after the location registration, including combinations such as with audio and other private services. Further, it shows a possibility that there is no need to operate a private (individually assigned) physical channel to notify the base station of feedback information, such as quality information and receiving notification (acknowledgement), in a terminal that operates to receive only the broadcast service and not to receive other services. When content of a common source is distributed to many terminals, it is not realistic to use a transmission method that is necessary to notify the base station side of reception at packet level from the individual terminals. For this reason, there is proposed to use error correction by an external code for improving the downlink performance from the base station to the terminals. The external code is positioned as an additional code executed in a higher layer, in addition to the coding executed in a physical layer of a wireless link. It also discloses a distribution method that is not necessary to provide feedback information by an uplink, in other words, that is constituted only by a downlink.

As described above, there are proposed methods to realize the broadcast and multicast services in mobile communication systems. From the point of view of efficient use of the wireless resource, the shared wireless link is used. The terminal receives in STAND-BY state without activating the communication channel that is necessary to provide the feedback information to the base station, as shown in JP-A 295170/2000 and JP-A No. 525032/2005.

Next, a usage pattern is assumed such that the content distributed by the broadcast service or multicast service is viewed in a mobile device such as a notebook computer or PDA. In this case, it is possible to configure that the content is received by a data communication card loaded into the mobile device. It is assumed that the display output and sound output of the content to the user is performed during communication (online) or at an arbitrary time instant after download (offline), relative to a corresponding device provided in the mobile device. A data communication card terminal, which is used in combination with a posterior mobile device, receives its power supply from the posterior terminal and thus reduction in power consumption is expected. Further, in order to facilitate the usability of the posterior terminal, the data communication card terminal is loaded in such a way that a portion thereof exposing outside the posterior terminal is as small as possible. Thus the display device for displaying the operation state of the data communication card to the user is expected to have low power consumption and be compact in size. For this reason there is proposed a data communication card using LEDs to display the operation state to the user, as described in JP-A No. 164807/2002. JP-A No. 164807/2002 describes that the emitting states of two LEDs are combined to display power ON/OFF, in a service area or out of a service area, and communicating or non-communicating (namely, STAND-BY state if in a service area).

In the mobile communication system supporting point-to-multipoint services such as the broadcast and multicast services, a usage pattern can be assumed such that the content is received in combination with the data communication card and the posterior terminal such as the notebook computer. At this time, communication states of the wireless link system, which are different from the communication states in the point-to-point service used in the past, are defined as the operation state of the data communication card. One of the newly added communication states is a state of receiving content by a downlink shared by many terminals, instead of activating the communication channel constituted by a pair of uplink and downlink for exclusive use of each terminal. Heretofore, no thorough study has been done on the state display of the data communication card with such added communication states taken into consideration.

Particularly in the broadcast and multicast services, a usage pattern is assumed such that the content is not only viewed in real time but also once downloaded and reproduced in an offline state, namely such that reservation receiving is performed. The reservation receiving is an application that automatically starts receiving operation according to a predetermined setting without operation by the user upon distribution of the content. This application service can be provided in combination with the data communication card and the posterior terminal.

Generally the flow of the reservation receiving operation is roughly divided into the following three steps: previous reservation setting; automatic execution of the reservation receiving; and content viewing after download or during download. These three steps respectively have the following problems in relation to availability for users: improvement in the certainty of the reservation; state display indicating that the reservation is in execution; and simple reproduction management based on the viewing authorization of the download content. As for the state display of the reservation in execution, the receiving is automatically started, so that it is necessary to prevent the user from interrupting the execution by mistake. The data communication card is loaded into the posterior terminal and then used, so that it is necessary to take into consideration possibility that the user may pull it out by mistake.

### SUMMARY OF THE INVENTION

The present invention relates to a data communication card of mobile communication system to be loaded into a posterior terminal such as a notebook computer, and an application program of the posterior terminal, in which the data communication card includes a state display function appropriate to the case of supporting point-to-point services as well as point-to-multipoint services such as broadcast and multicast services. More particularly the invention provides a data communication card, a program, and a computer readable recording medium on which the program is recorded, which are appropriate for executing a reservation receiving application.

The foregoing can be achieved by providing a data communication card connected to a computer to connect the computer to a base station of mobile communication system. The data communication card includes a display that allows to discriminate among the states of a first STAND-BY state of waiting for a call from the base station, a second STAND-BY state of receiving content by a downlink for broadcast from the base station, and of a connection state of activating a communication channel exclusively assigned to communicate with the base station.

Further it can be achieved by providing a program for causing a computer to which a data communication card for connection with a base station of mobile communication system is connected, to function as a card control section for obtaining a time from the base station via the data communication card, and as an internal clock correction section for correcting an internal clock of the computer to the time.

Further it can be achieved by providing a program for causing a computer to which a data communication card for connection with a base station of mobile communication system is connected, to function as a card control section for receiving encrypted management information from the data communication card, a management information decoding section for decoding the encrypted management information received by the card control section, and as a content decoding section for decoding encrypted content by a key included in the management information decoded by the management information decoding section.

### BRIEF DESCRIPTION OF THE DRAWINGS

Preferred embodiments of the present invention will now be described in conjunction with the accompanying drawings, in which:

FIG. 1 is a block diagram illustrating a reservation receiving system with a data communication card loaded into a card slot of a notebook computer;

FIG. 2 is a block diagram illustrating a controller of the data communication card;

FIG. 3 is a block diagram illustrating a destination to which encrypted content is stored;

FIG. 4 is a block diagram illustrating the functional configuration of a reservation receiving application;

FIG. 5 is a hardware block diagram of the notebook computer;

FIG. 6A is a top view of a CD-ROM and FIG. 6B is a side view of the CD-ROM;

FIG. 7 is a sequence diagram illustrating-the operation when the content is received; and

FIG. 8 is a sequence diagram illustrating the operation when the content is reproduced.

### DETAILED DESCRIPTION OF THE PREFERRED EMBODIMENTS

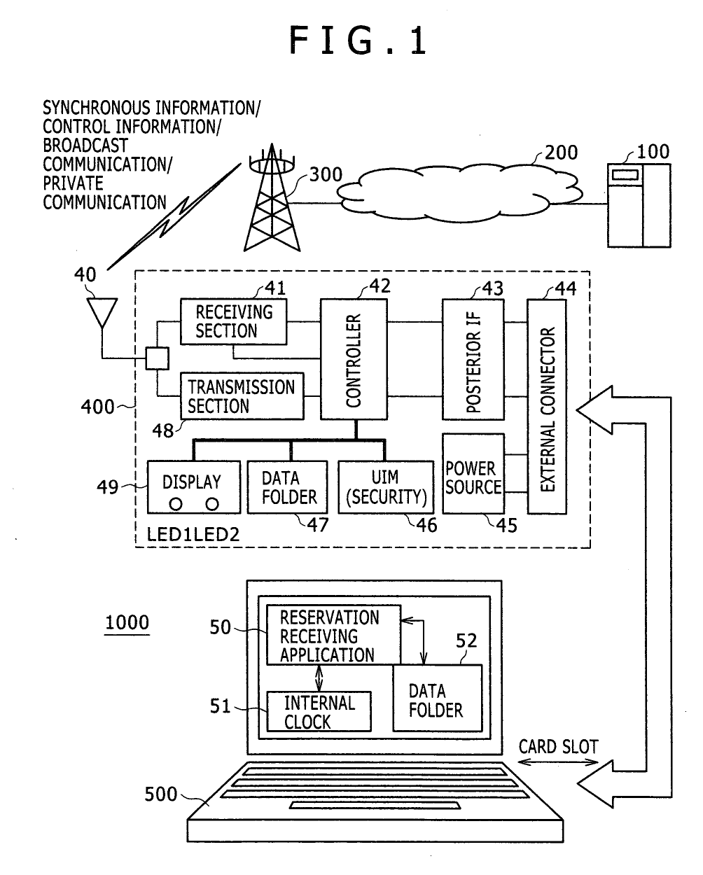

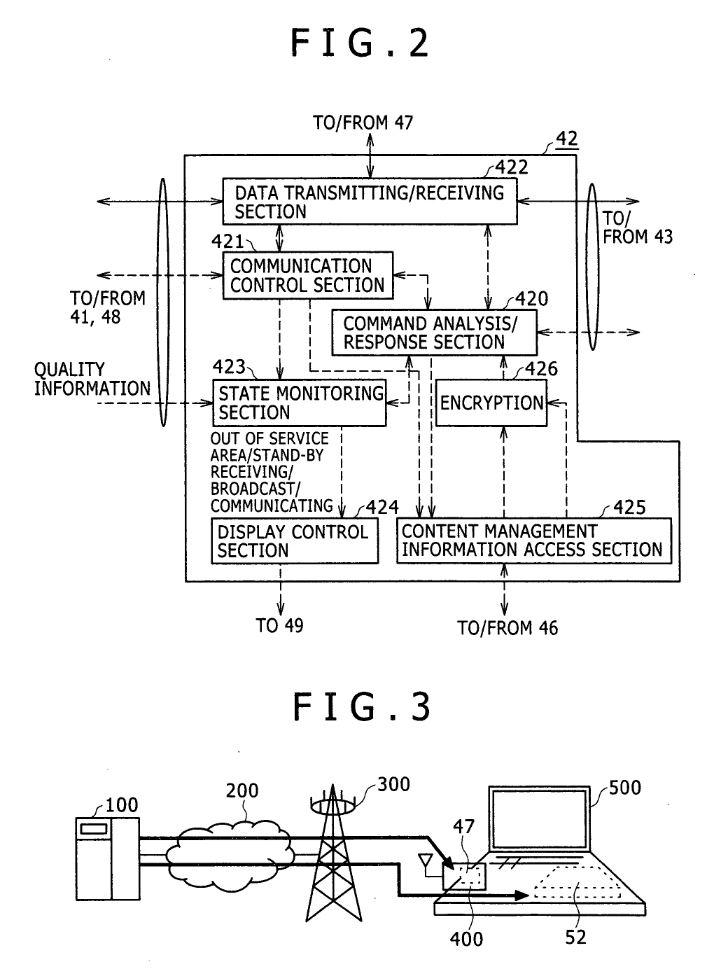

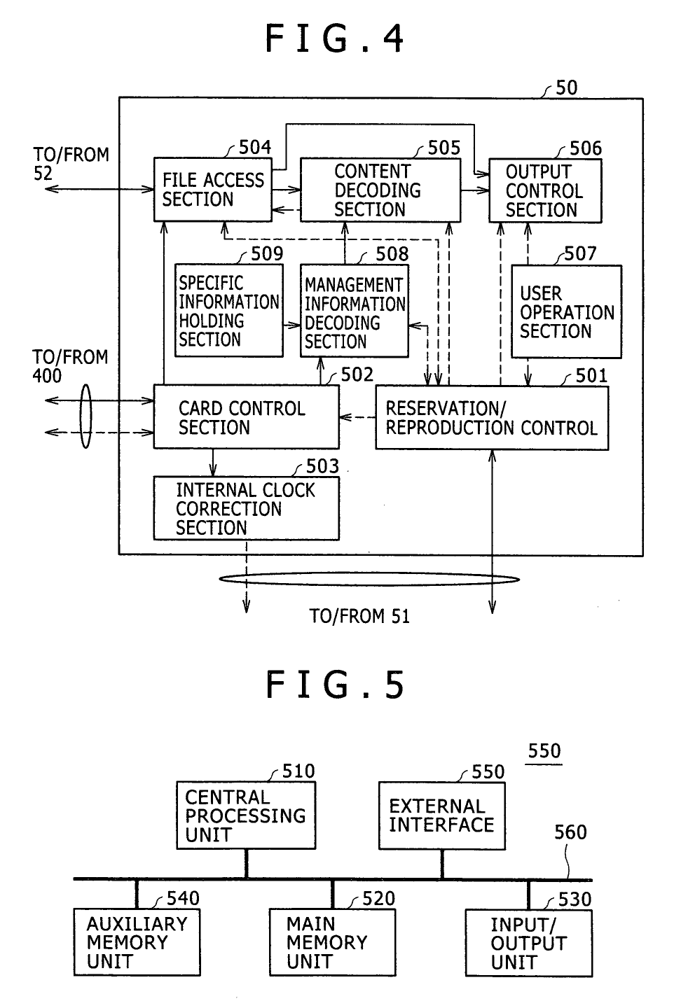

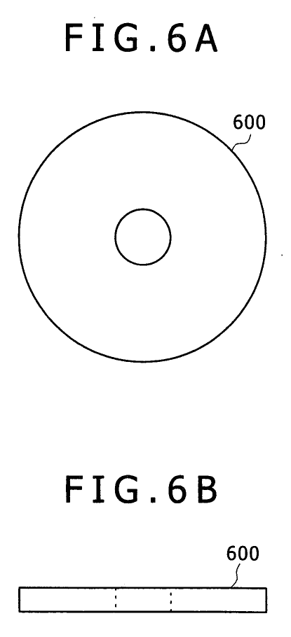

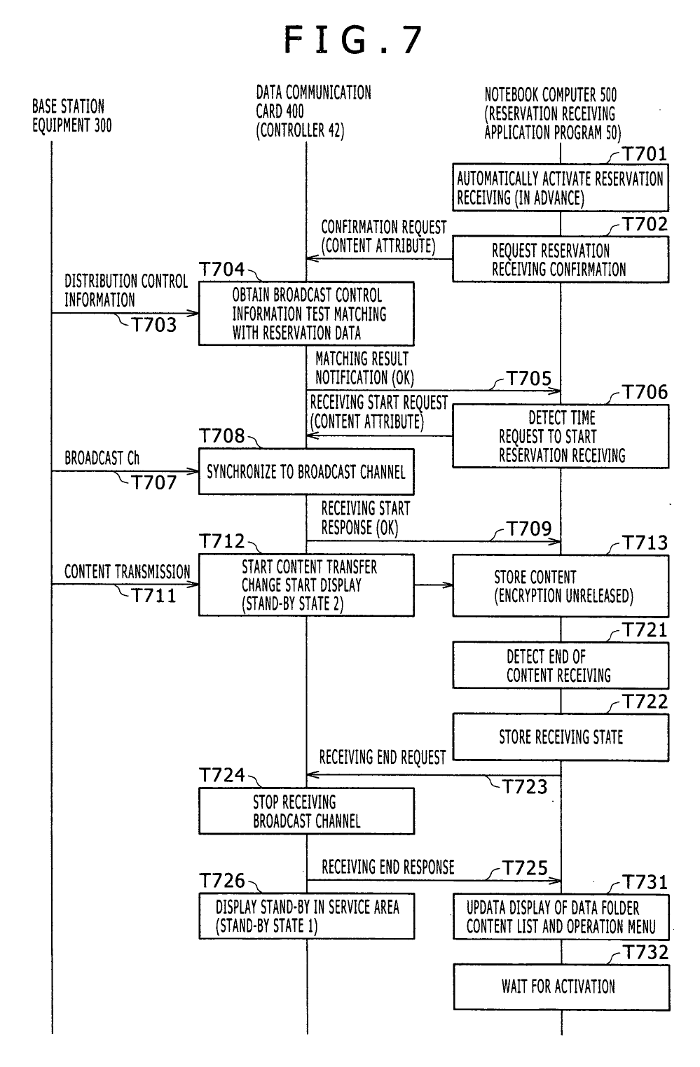

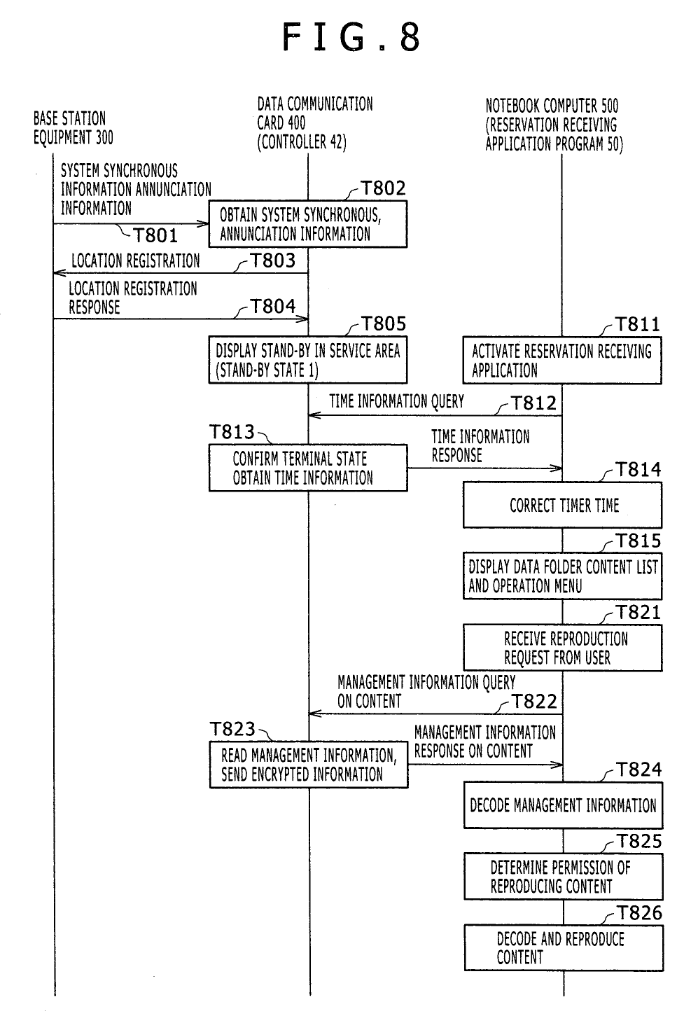

Modes for carrying out the present invention will be described below based on an embodiment with reference to the accompanying drawings. Here FIG. 1 is a block diagram illustrating a reservation receiving system with a data communication card loaded into a card slot of a notebook computer. FIG. 2 is a block diagram illustrating a controller of the data communication card. FIG. 3 is a block diagram illustrating a destination to which encrypted content is stored. FIG. 4 is a block diagram illustrating the functional configuration of a reservation receiving application. FIG. 5 is a hardware block diagram of the notebook computer. FIG. 6A is a top view of a CD-ROM and FIG. 6B is a side view of the CD-ROM. FIG. 7 is a sequence diagram illustrating the operation when the content is received. FIG. 8 is a sequence diagram illustrating the operation when the content is reproduced.

In FIG. 1, a reservation receiving system 1000 includes: server equipment 100 for content distribution; base station equipment 300 which is a wireless access point of a mobile communication system; a network 200 for connecting the server equipment 100 with the base station equipment 300; a data communication card 400; and a notebook computer 500 to be a posterior terminal of the data communication card 400. Content distributed from the server equipment 100 arrives at the base station equipment 300 via the network 200 by a communication protocol based on IP multicast. The mobile communication system including the base station equipment 300 supports the broadcast and multicast services, in which the data communication card 400 receives the content by a wireless downlink for broadcast shared by many terminals.

The mobile communication system according to the embodiment is a system of CDMA meeting the 3GPP2 (3rd Generation Partnership Project 2) standard. In this case, the wireless base station equipment 300 sends a down wireless interface in which the following channels are defined in addition to the downlink for broadcast: a pilot channel for trapping the mobile communication system; a synchronous channel for transmitting time synchronous information of the mobile communication system; a paging channel for transmitting a terminal call and annunciation information; and a traffic channel exclusively assigned to each terminal.

The data communication card 400 is loaded into the card slot of the notebook computer 500, and is controlled by a reservation receiving application program 50 to access the base station equipment 300. At this time necessary parameters are obtained from the paging channel so that the communication card 400 is matched to the transmission conditions of the base station equipment 300. The data communication card 400 traps the valid pilot channel and obtains the system synchronous information from the synchronous channel, and then can receive the paging channel. The data communication card 400 provides a location registration to the trapped base station equipment 300 by use of parameters announced on the paging channel. In this way a call from the mobile communication system is available. Then the data communication card 400 moves to STAND-BY state to continuously monitor the paging channel.

The data communication card 400 includes: a transceiver antenna 40; a receiving section 41 for receiving and processing a wireless signal; a controller 42 for performing call control of the data communication card, data flow control, and operation control of the sections of the data communication card; a transmission section 48 for modulating and converting data output by the controller 42 into a radio signal, power amplifying the radio signal, and outputting to the transceiver antenna 40; a posterior interface 43 for processing a communication protocol for an external interface such as USB or PCMCIA to intermediate a command and traffic data between the controller 42 and the notebook computer 500; an external connector 44 for connecting to the notebook computer 500; a power source 45 for standardizing power supplied from the notebook computer 500 via the external connector 44 and supplying the power to the sections of the data communication card; a UIM (User Identification Module) 46 for outputting identification information specific to the data communication card, to the controller 42; a data folder 47 for storing content; and a display 49 for displaying the state of the data communication card to the user by driving LED 1 and LED 2, under the control of the controller 42. Here the UIM 46 is an IC on which contractor information issued by a cellular phone company is recorded, which is used for identifying the user of the data communication card.

Under the control of the controller 42, the frequency and sector to be received are specified in the receiving section 41 that operates to receive a function channel specified in the same way. In other words, the trapping of the pilot channel, the reception of the synchronous channel, and the switching of the receiving operation of the paging channel are all performed by the controller 42. The controller 42 obtains the service state for broadcast announced on the paging channel, controls the receiving section 41 according to the command given via the external connector 44 and the posterior interface 43. In this way it is possible to start receiving the downlink for the broadcast service.

The notebook computer 500 can execute the reservation receiving application program 50 on a memory. The notebook computer 500 further includes a data folder 52 that the reservation receiving application program 50 can access, and an internal clock 51 whose time can be adjusted from the application program 50. When a recording reservation time predetermined by the user is notified from the internal clock 51, the reservation receiving application program 50 automatically activates, and automatically receives the content distributed by the server equipment 100 through the mobile communication system supporting the broadcast service, and then stores the content to the data folder 52. The reservation receiving application program 50 reproduces the stored content according to the user operation. The reservation receiving application program 50 issues a command necessary for the reservation receiving operation to the controller 42 of the data communication card 400, while obtaining information necessary for reproducing the stored content upon reproduction from the data communication card 400.

The outline of the reservation receiving system 1000 has been described above. In this configuration, a description will be made on the display of the operation state in the data communication card 400 followed by description on the improvement in the certainty of the reservation and on the viewing management.

The controller 42 of the data communication card 400 monitors the state of the wireless link with the base station equipment 300. In FIG. 2, the controller 42 includes a command analysis/response section 420, a communication control section 421, a data transmitting/receiving section 422, a state monitoring section 423, a display control section 424, a content management information access section 425, and an encryption (scramble) section 426. In FIG. 2, the communication data flow is indicated by solid line arrows and the control data flow is indicated by broken line arrows.

The command analysis/response section 420 analyzes the command from the notebook computer 500, and instructs the communication control section 421 to transmit data communication, obtain annunciation information, and to start and stop receiving broadcast. The command analysis/response section 420 further instructs the state monitoring section 423 to update the information. The state monitoring section 423 monitors the quality information such as the type of channel that the communication control section 421 receives or activates, the electric field strength of its wireless link, and the pilot strength, and then reports to the command analysis/response section 420. The state monitoring section 423 outputs state values of the data communication card to the display control section 424. The state values are provided, as shown in Table 1, to discriminate among the following four states indicating: whether the communication card is out of the service area in which the pilot channel cannot be trapped; whether the communication card is in STAND-BY state in which a call is available; whether the communication card is receiving the downlink for broadcast; and whether the data communication card is performing communication. The display control section 424 outputs a display pattern for driving the light emission devices LED 1 and LED 2, to the display 49 in response to the input state values. The display pattern is to discriminate between the STAND-BY state in which a call is available (STAND-BY state 1) and the state of receiving the downlink for broadcast (STAND-BY state 2). More specifically, one of the four types of light emission patterns shown in Table 1 is output.

The light emission patterns are configured so that an LED 1 indicates the power supply state and an LED 2 indicates the state of the wireless link. More specifically, the LED 1 turns on or flashes to indicate that the power supply is valid by the power source 45 of the data communication card 400, while turning off to indicate that the power supply is blocked. The LED 2 turns green to indicate a normal STAND-BY state, while flashing green to indicate a state of receiving the downlink for broadcast, which is the STAND-BY state 2. In the connection state in which the private communication channel is individually activated between the data communication card and the base station equipment 300, the LED 2 flashes green and at the same time the LED 1 also flashes green so that the connection state can be discriminated from the STAND-BY state 2. Further, the LED 2 turns green when outside the service area. In addition, the LED 2 turns off when the power supply is blocked.

TABLE 1

| | STAND-BY | | STAND-BY | | Connection | | Out of | |
|---|---|---|---|---|---|---|---|---|
| | State 1 | | State 2 | | State | | Service Area | |
| LED 1 (Power) | Green | ON | Green | ON | Green | Flashed | Green | ON |
| LED 2 (Link) | Green | ON | Green | Flashed | Green | Flashed | Red | ON |

With the state monitoring and display control according to the embodiment, the user can recognize that the reservation receiving is in execution by discriminating from the normal STAND-BY state. Further the user can also recognize the execution by discriminating from the connection state that is necessary to send user data.

Taking into consideration the usage patterns of the reservation receiving, there are a case in which receiving and storing are automatically performed when the user is not present, and a case in which the user is in the same place as the notebook computer 500 with the terminal in an unused state, and does not realize start and execution of the reservation receiving. An example of the latter case is of the reservation receiving executed in a state in which the notebook computer is closed. At this time, the user would be likely to pull out the data communication card during execution of the reservation receiving by mistake, unless it is discriminated from the normal STAND-BY state. In addition, when it is not discriminated from the normal connection state, the reservation receiving operation may be misconstrued as a state in which a transmission the user does not desire is performed by a computer virus. The STAND-BY state 2 is exclusively provided separately from the other states, so that it is possible to reduce the possibility of the data communication card being pulled out during the receiving operation as well as the possibility of misidentification.

Particularly, the notebook computer for mobile use has a high demand for power consumption saving with the assumption that it is battery driven. Thus it is possible to add an option of not outputting the display of the execution state of the reservation receiving application program 50 having automatically activated, on a computer display. In this case the power reduction effect is large.

In FIG. 2, the data transmitting/receiving section 422 sends and receives traffic data in the connection state with the receiving section 41 and the transmission section 48, while receiving broadcast reception data in the STAND-BY state 2. The data transmitting/receiving section 422 adjusts with data flow control of the posterior interface 43. The data transmitting/receiving section 422 outputs the received broadcast reception data to the posterior interface 43 or the data folder 47 according to the instruction of the command analysis/response section 420. Further the data transmitting/receiving section 422 transfers the data stored in the data folder 47 to the posterior interface 43 according to the instruction of the command analysis/response section 420.

Now a description will be made on the storage of the encrypted content received in the broadcast service. In FIG. 3, the encrypted content indicated by arrows is sent from the server equipment 100 and received by the data communication card 400 via the network 200 and the base station equipment 300. The encrypted content received by the data communication card 400 is stored either in the data folder 47 of the data communication card 400 or in the data folder 52 of the notebook computer 500. With such a configuration, it is possible to use the data communication card as a temporal buffer when the capacity of the data folder 52 of the notebook computer 500 runs short. In the embodiment, the content is encrypted in the server equipment 100 and the encrypted content is stored without being converted into plain text, to the data folder 47 or 52. As is apparent from the configuration described above, the decoding function of the encrypted content is included in the reservation receiving application program 50 that performs decoding only when the content is reproduced.

The encryption of the content is converted into plain text by use of the management information including key information and expiration information to break the encryption. Such management information is read from the UIM 46 via the content management information access section 425 according to the instruction of the command analysis/response section 420. Thus it is necessary to load the communication card 400 into the notebook computer 500 in order to view the content. Further it is designed that the management information read by the content management information access section 425 is transferred to the posterior interface 43 via the encryption section 426. Here the encryption section 426 encrypts the content management information with the specific information of the data communication card stored in the UIM 46 as a key. The content management information is encrypted in such a way that the encryption can be decoded by the specific information or any information related thereto. The key for the decoding is provided in the reservation receiving application program 50 in advance. The encryption of the management information serves as protection against tapping of communication between the reservation receiving application program 50 and the data communication card 400. In the reservation receiving system constituted by the data communication card and the notebook computer 500, which is different from the application implemented in a cellular phone terminal, tapping by a physical relay substrate inserted into the card slot is possible. With the above configuration, it is possible to improve confidentiality of the interface between the notebook computer 500 and the data communication card.

Next a description will be made on the functional configuration of the reservation receiving application program 50 to be executed in the notebook computer. In FIG. 4, the reservation receiving application program 50 causes the computer to function as a reservation receiving/reproduction control section 501, a card control section 502, an internal clock correction section 503, a file access section 504, a content decoding section 505, an output control section 506, a user operation section 507, a management information decoding section 508, and a specific information holding section 509.

The reservation receiving/reproduction control section 501 outputs the instruction to the card control section 502 for automatically receiving content according to the reservation setting entered through the user operation section 507. The reservation receiving/reproduction control section 501 also instructs the card control section 502 to request the content management information for the purpose of reproducing the content through the operation by the user. Further, the reservation receiving/reproduction control section 501 controls the file access section 504 to read the stored content from the data folder 47 via the data folder 52 or the card control section 502. The reservation receiving/reproduction control section 501 controls the decoding of the content management information as well as the decoding of the content itself.

The card control section 502 issues a command to the data communication card 400 according to the instruction of the reservation receiving/reproduction control section 501, receives a response to the command, and transfers the response to the reservation receiving/reproduction control section 501. The card control section 502 respectively outputs the broadcast reception data to the file access section 504, the content management information to the management information decoding section 508, and the system time information included in the synchronous channel to the internal clock correction section 503. The system time information is the annunciation information sent from the base station equipment 300. In the cellular phone of CDMA system defined by 3 GPP 2, the system time information is synchronous with the GPS time which is very accurate time. Based on the GPS time, the reservation receiving application program 50 corrects the time of the internal clock 51 of the notebook computer 500 by the internal clock correction section 503. The reservation receiving/reproduction control section 501 starts the reservation receiving based on the time of the internal clock 51. With such a configuration, an accurate time of reservation execution is provided, so that the certainty of the reservation is improved.

The content management information is converted into plain text by the management information decoding section 508 using the key information output from the specific information holding section 509. Then the content management information is input to the content decoding section 505. The content decoding section 505 converts the content output from the file access section 504 into plain text while reproducing video encoded data and sound data, and then outputs to the output control section 506. The output control section 506 sends the video encoded data to a video decoding section (not shown) of the notebook computer 500 in which the video is displayed on a liquid crystal panel. Further, the output control section 506 sends the sound data to a speaker (not shown) of the notebook computer 500 in which the sound is reproduced.

The hardware configuration of the notebook computer will be described with reference to FIG. 5. In FIG. 5, the notebook computer 500 includes: a central processing unit (CPU) 510; a main memory unit (memory) 520; an input/output unit 530 including input devices such as a keyboard and a pointing device as well as output devices such as the liquid crystal panel and speaker; an auxiliary memory unit 540 such as a hard disk device and a flash memory; and an external interface 550 for connecting peripheral equipment such as a CD-ROM drive and card slot, all of which are connected by a bus 560. The reservation receiving application program 50 recorded on the CD-ROM is read in from the input/output unit 530, and is copied to the auxiliary memory unit 540. The reservation receiving application program 50 copied to the auxiliary memory unit 540 is executed on the main memory unit 520 by the central processing unit 510.

FIG. 6A is a top view of the CD-ROM on which the reservation receiving application program 50 is recorded. FIG. 6B is a side view of the CD-ROM on which the reservation receiving application program 50 is recorded. The reservation receiving application program 50 is recorded on a lower surface (recording surface) in FIG. 6B, which is then attached to a spindle of the CD-ROM drive to read the program. It is to be noted that the computer readable recording medium for the reservation receiving application program is not limited to the CD-ROM, and other recording media such as CD-R, DVD, and FD may be used.

The state transition among the data communication card, the notebook computer, and the base station equipment is further described with reference to FIG. 7. In FIG. 7, the reservation receiving application program automatically activates at a few minutes before the distribution time of the reserved content in the notebook computer 500 (T701). Next the reservation receiving application program sends a command of distribution confirmation including the content attribute to the data communication card 400, in order to confirm whether the content set in the reservation step is distributed from the base station equipment 300 in which the data communication card 400 is currently roaming (T702). Upon receiving the command of confirmation request, the data communication card 400 receives the distribution control information sent by the base station equipment 300 (T703), and performs a matching test for the content attribute (T704). Here it is assumed that there is no problem in the matching result. The data communication card 400 sends the matching result notification (OK) to the notebook computer 500 (T705).

The reservation receiving application program 50 receives an acceptance notification of the matching result and permits execution of the reservation receiving. Then the reservation receiving application program 50 detects the reservation time from timekeeping data in the internal clock 51, and sends a request command to the data communication card 400 to start the reservation receiving (T706). The data communication card 400 receives a broadcast channel from the base station equipment 300 (T707), and synchronizes to the channel for the broadcast (T708). Here it is assumed that the synchronization has been successfully done. The data communication card 400 sends a receiving start response to the notebook computer 500 (T709).

The base station equipment 300 starts transmitting the content at the fixed time (T711). Then the data communication card 400 starts transferring the data kept encrypted as it is received from the broadcast channel, to the notebook computer 500. At the same time, the data communication card 400 switches the state display of the display 49 to the STAND-BY state 2 (T712). Along with this, the reservation receiving application program 50 stores the transferred data to the data folder 52 (T713). Upon detection of end of the content (T721), the reservation receiving application program 50 stores the reception state (done, failed, and the like) (T722). Here it is assumed that the reception state is “done”. The reservation receiving application program 50 sends a receiving end request command to the data communication card 400 (T723). Upon receiving the receiving end request command, the data communication card 400 stops receiving the broadcast channel (T724) and sends a receiving end response (T725). Then the data communication card 400 returns the state display to the STAND-BY state 1 (T726).

The reservation receiving application program 50 updates the display of a data folder content list including the reception state and of an operation menu (T731). The reservation receiving application program 50 moves to the state of waiting for the next automatic activation, after a predetermined time has passed without operation by the user (T732).

Finally, the operation sequence in content reproduction will be described with reference to FIG. 8. In FIG. 8, when the data communication card 400 is loaded into the card slot with the power on of the notebook computer 500, the power is supplied to the power source 45 via the external connector 44 to activate the data communication card 400. The data communication card 400 traps the pilot channel periodically sent by the base station equipment 300 (T801), and obtains the system synchronous and annunciation information by the synchronous channel (T802). The data communication card 400 provides a location registration to the base station equipment 300 (T803). The base station equipment 300 receives the location registration and sends a location registration response to the data communication card 400 (T804). Upon receiving the location registration response, the data communication card 400 displays the STAND-BY state 1 as the data communication card state (T805).

At this stage, it is assumed that the user manually activates the reservation receiving application (T811). The activated reservation receiving application program 50 first sends a time information query to the data communication card 400 (T812). The data communication card 400 confirms the state monitoring section 423 about the quality information on the wireless link, detects the system time information via the communication control section 421, and sends a time information response including valid time information (T813). The reservation receiving application program 50 corrects the internal clock time in response to the time information (T814). Then the reservation receiving application program 50 displays the current content list of the data folder as well as the operation menu (T815).

Here it is assumed that the user selects content according to a menu guide and requests to reproduce the selected content. The reservation receiving application program 50 receives the request (T821), and sends a query to the data communication card 400 regarding the management information on the relevant content (T822). The controller 42 of the data communication card 400 reads the management information from the UIM 46, encrypts the data by the encryption section 426, and sends a management information response to the notebook computer 500 (T823). The application program 50 decodes the received management information into plain text based on the key output from the specific information holding section 509 (T824). Then the application program 50 checks the viewing limit included in the management information to determine whether the content reproduction is permitted or prohibited (T825). When it is within the limit, the application program 50 converts the encryption of the content into plain text by the key included in the management information. In this way the compressed encoded data is decoded (T826).

According to the embodiment, the operation state display of the data communication card is provided to discriminate the execution of the reservation receiving from the other stand-by state, so that the user can confirm that the reservation receiving is in execution. Thus it is possible to prevent the action of pulling out the data communication card from the notebook computer by mistake.

Further, according to the embodiment, the clock of the notebook computer is synchronous with the system time of the mobile communication system that performs distribution, so that the certainty of the reservation receiving is improved.

Further, according to the embodiment, the content is not permitted to be reproduced by the application program and the recording medium on which the program is recorded, unless the data communication card having received the relevant content is loaded. Thus it is possible to perform viewing management limited to the owner of the data communication card.

According to the present invention, the operation state display of the data communication card is provided to discriminate the execution of the reservation receiving from the other stand-by state, so that the user can confirm that the reservation receiving is in execution. Thus it is possible to prevent the action of -pulling out the data communication card from the posterior terminal by mistake.

Further, according to the invention, the internal clock of the posterior terminal is synchronous with the system time of the mobile communication system that performs distribution, so that the certainty of the reservation receiving is improved.

Further according to the present invention, the content is not permitted to be reproduced by the application program, unless the communication card having received the relevant content is loaded. Thus it is possible to perform viewing management limited to the owner of the data communication card.

We claim:

1. A data communication card connected to a computer to connect the computer to a base station of a mobile communication system, said data communication card comprising a display for differentially displaying:
a first STAND-BY state of waiting for a call from said base station;
a second STAND-BY state of receiving content by a downlink for broadcast from said base station; and
a connection state of activating a communication channel exclusively assigned to communicate with said base station.

2. The data communication card according to claim 1,
wherein said display displays that said data communication card is outside a service area as a further different state.

3. A program for causing a computer to which a data communication card for connection with a base station of a mobile communication system is connected, to function as:
a card control section for obtaining time from said base station via said data communication card; and
an internal clock correction section for correcting an internal clock of said computer to said time.

4. A computer readable recording medium on which a program is recorded to cause a computer to which a data communication card for connection with a base station of a mobile communication system is connected, to function as:
a card control section for obtaining time from said base station via said data communication card; and
an internal clock correction section for correcting an internal clock of said computer to said time.

5. A program for causing a computer to which a data communication card for connection with a base station of a mobile communication system is connected, to function as:
a card control section for receiving encrypted management information from said data communication card;
a management information decoding section for decoding said encrypted management information received by said data communication card; and
a content decoding section for decoding encrypted content by a key included in the management information decoded by said management information decoding section.

6. A computer readable recording medium on which a program is recorded to cause a computer to which a data communication card for connection with a base station of a mobile communication system is connected, to function as:
a card control section for receiving encrypted management information from said data communication card;
a management information decoding section for decoding said encrypted management information received by said card control section; and
a content decoding section for decoding encrypted content by a key included in the user management information decoded by said management information decoding section.
